(19) United States
(12) Patent Application Publication
(10) Pub. No.: US 2016/0052364 A1
(43) Pub. Date: Feb. 25, 2016

(54) VEHICULAR AIR CONDITIONER

(71) Applicant: Mitsubishi Electric Corporation, Chiyoda-ku, Tokyo (JP)

(72) Inventors: Yasuyuki SOGAWA, Chiyoda-ku, Tokyo (JP); Yukio NISHIDA, Chiyoda-ku, Tokyo (JP)

(73) Assignee: Mitsubishi Electric Corporation, Chiyoda-ku, Tokyo (JP)

(21) Appl. No.: 14/780,856

(22) PCT Filed: Jun. 28, 2013
(86) PCT No.: PCT/JP2013/067807

§ 371 Date: Sep. 28, 2015

(51) Int. Cl. B60H 1/00; B60H 1/26

(52) U.S. Cl. CPC B60H 1/00849; B60H 1/26; B60H 2001/3289

(57) ABSTRACT

In a vehicular air conditioner in which heat of recirculated air inputted by an indoor air blower, is exchanged by an indoor heat exchanger so as to be retransmitted to a vehicle, there are provided with a cyclone fan, which aspirates heavy fresh outside air including snow or the like, so as to mix the outside air with the recirculated air inputted by the indoor air blower, and a partition plate, which separates light air in which snow or the like is not included, and heavy air in which snow or the like is included, by centrifugal force of the cyclone fan at a blowoff outlet of the cyclone fan.

### BACKGROUND OF THE INVENTION

1. Technical Field

The present invention relates to a rail car air conditioning unit, and particularly relates to a vehicular air conditioner in which a material, such as snow or rain, which invades from an outside-air inlet, is separated by a cyclone fan, whereby outside air including the material is not inputted to a vehicle.

2. Background Art

It is general that a conventional vehicular air conditioner is mounted to an upper portion of a vehicle, and fresh outside air is inputted from an outside-air inlet, which is provided at a side surface or an upper surface of the vehicular air conditioner, to the inside of the vehicle by a blower for inputting the outside air, and the inputted outside air is mixed with recirculated air which is aspirated by an indoor air blower, and then heat of the outside air is exchanged by an indoor heat exchanger, and the outside air, of which heat is exchanged, is fed in a cabin (for example, refer to Patent Document 1).

However, in the conventional vehicular air conditioner, although snow, rain or the like, which invades from an outside-air inlet provided at a side surface or an upper surface of the vehicular air conditioner, is usually removed by a filter, a wire net or the like, which is provided at the outside-air inlet, there is a case in which the filter, the wire net or the like is clogged and the fresh outside air cannot be inputted, and there is a case in which minute snow or rain is passed through the filter, the wire net or the like and invades to the inside of the vehicular air conditioner, so that there have been problems in that a performance of the vehicular air conditioner is reduced.

On the other hand, in order to prevent that a material, such as snow or rain, invades to a room of a vehicle, there is a submitted vehicular air conditioner in which an air passage, which is inputted from an outside-air inlet provided at a side surface, is separated to an upper duct and a lower duct, and the fresh outside air is inputted through the upper duct, and snow is melted by a heater at the outside air passage (for example, refer to Patent Document 2). Moreover, in order to prevent an influence of a drive wind, there is a submitted vehicular air conditioner in which the outside-air wind tunnel for inputting the outside air is provided (for example, refer to Patent Document 3).

However, a wind velocity at the outside-air inlet is not sufficiently reduced by the methods described in Patent Document 2 and Patent Document 3, so that a snow-melting effect is not sufficiently acted by the heater. Moreover, in order to act the heater, it is required that a long outside-air passage is extended from the outside-air inlet, or a heater having a large heat capacity is designed, so that the methods described in Patent Document 2 and Patent Document 3 are not always effective in consideration of a snow-melting effect and a cost advantage.

### CONVENTIONAL ART DOCUMENT

### Patent Document

Patent Document 1: Japanese Utility Model Publication No. S59-120620

Patent Document 2: Japanese Laid-Open Patent Publication No. 560-67215

Patent Document 3: Japanese Laid-Open Patent Publication No. 2011-213206

### SUMMARY OF THE INVENTION

### Problems to be Solved by the Invention

The present invention has been made to solve above-described problems, and an object of the invention is to provide a vehicular air conditioner in which outside air, which is inputted from an outside-air inlet, is separated in accordance with a mass so as to be inputted to a vehicle.

Means for Solving Problems

A vehicular air conditioner of the present invention includes an indoor equipment room which is composed of at least an indoor air blower and an indoor heat exchanger in a state where outside air, which is inputted from an outside-air inlet, is mixed with recirculated air, which is aspirated by the indoor air blower, and then the mixed air is outputted to a cabin via the indoor heat exchanger; wherein a cyclone fan, by which the inputted outside air is separated, by centrifugal force, to outside air, of which mass is lighter than a predetermined mass, and outside air, of which mass is heavier than a predetermined mass, is provided; and a partition plate, by which a passage of the outside air, of which mass is lighter than the predetermined mass, is partitioned from a passage of the outside air, of which mass is heavier than the predetermined mass, is provided at a blowoff outlet of the cyclone fan.

Effects of the Invention

In a vehicular air conditioner according to the present invention, a cyclone fan having a partition plate is provided in an indoor equipment room, and outside air is aspirated by the cyclone fan, and the outside air is separated, in accordance with a mass, by centrifugal force of the cyclone fan. Therefore, even when the outside air having a mass being heavier than a predetermined mass, in which snow or the like is included, is aspirated, the vehicular air conditioner has an effect in which snow, rain or the like can be effectively removed by a simple configuration, and the outside air can be inputted to a cabin of a vehicle.

### BRIEF DESCRIPTION OF THE DRAWINGS

FIGS. 1A through 1C are schematic diagrams illustrating an equipment arrangement and a flow of outside air in a vehicular air conditioner according to Embodiment 1 of the present invention;

FIG. 2 is an enlarged diagram illustrating a blowoff unit of a cyclone fan according to Embodiment 1 of the present invention;

FIGS. 3A and 3B are enlarged diagrams illustrating a blowoff unit of a cyclone fan according to Embodiment 2 of the present invention;

FIGS. 4A and 4B are schematic diagrams illustrating an equipment arrangement and a flow of outside air in a vehicular air conditioner according to Embodiment 3 of the present invention;

FIGS. 5A through 5C are schematic diagrams illustrating an equipment arrangement and a flow of outside air in a vehicular air conditioner according to Embodiment 4 of the present invention; and

FIGS. 6A and 6B are schematic diagrams illustrating an equipment arrangement and a flow of outside air in a conventional vehicular air conditioner.

### MODE FOR CARRYING OUT THE INVENTION

### Embodiment 1

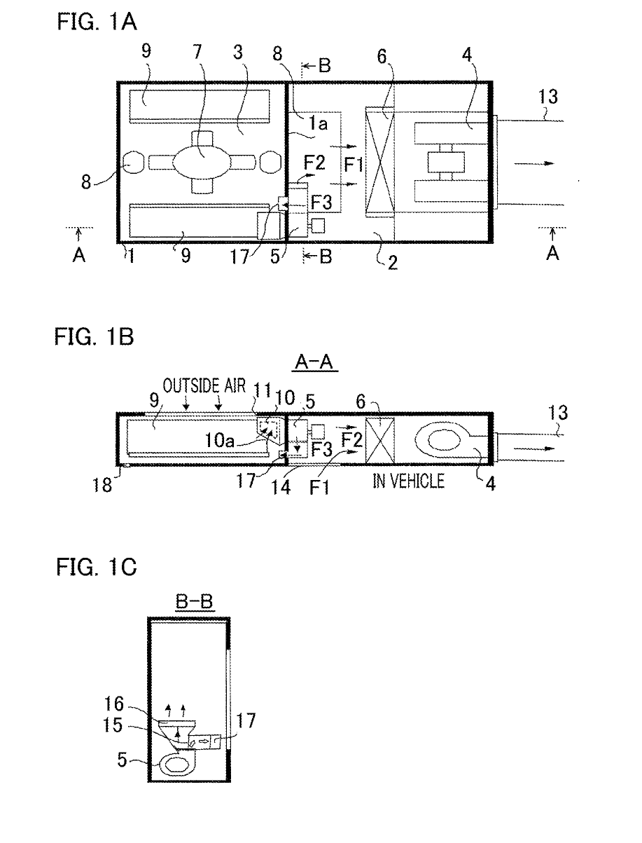

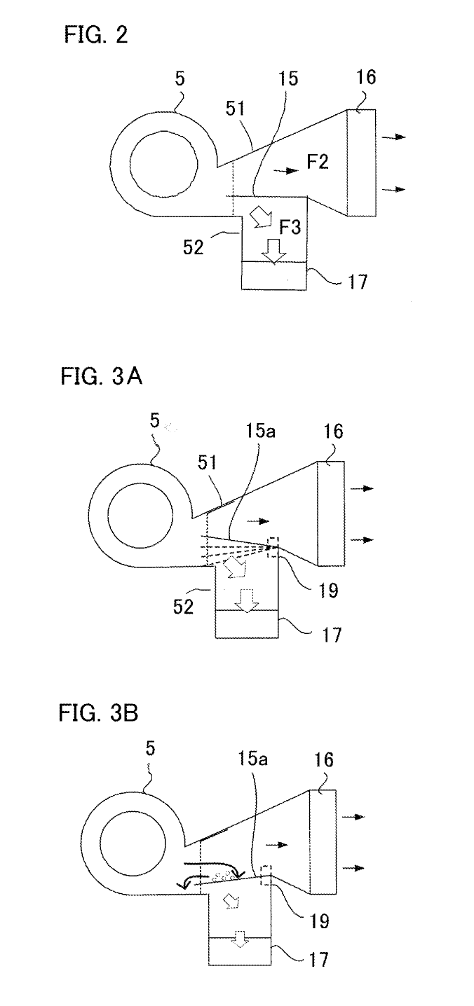

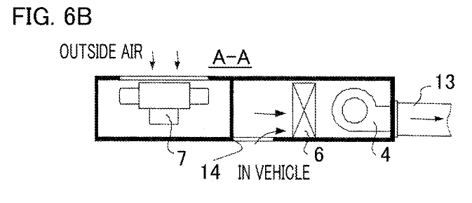

FIGS. 1 are schematic diagrams illustrating an equipment arrangement in a vehicular air conditioner according to Embodiment 1 of the present invention, and FIG. 1A illustrates a topside cross-sectional view, and FIG. 1B illustrates a front cross-sectional view along an “A-A” line, and FIG. 1C illustrates a side cross-sectional view along a “B-B” line. FIG. 2 is an enlarged cross-sectional view illustrating a blowoff unit of a cyclone fan illustrated in FIGS. 1. Hereinafter, each of equipment configurations and a flow of outside air will be explained in comparison with a conventional vehicular air conditioner illustrated in FIGS. 6.

In FIGS. 1, an air conditioner 1 is disposed at an upper portion of a vehicle, and the air conditioner 1 is composed of an indoor equipment room 2 and an outdoor equipment room 3, and moreover, an indoor air blower 4, a cyclone fan 5, and an indoor heat exchanger 6 are disposed in the indoor equipment room 2. An outdoor air blower 7, a compressor 8, outdoor heat exchangers or heaters 9, and a first duct for inputting fresh outside air, in other words, an outside-air intake duct 10 are disposed in the outdoor equipment room 3. The cyclone fan 5 is configured in such a way that the outside air, which is aspirated as illustrated in FIG. 1C, is branched by a partition plate 15, and one side of the branched outside air is guided to the indoor equipment room 2 via a filter 16, and the other side of the branched outside air is returned to the outdoor equipment room 3 via a second duct, in other words, an ejection duct 17, which is provided at a part of a partition 1a. In addition, the filter 16 may be composed of a unit by which a material having a relatively heavy mass, such as snow, is removed from the inputted outside air, and the filter 16 may be composed of, for example, a wire net.

Hereinafter, a flow of the outside air, which is caused in accordance with an operation of the vehicular air conditioner 1, will be explained. The outside air, which is inputted from an outside-air inlet 11 in accordance with an operation of the outdoor air blower 7, is aspirated from a lower portion 10a of the outside-air intake duct 10 in accordance with an operation of the cyclone fan 5, and a material having a relatively heavy mass is separated from air having a light mass by centrifugal force of cyclone fan 5 and an action of the partition plate 15, and the air having a light mass is passed through the filter 16. In addition, the material having a heavy mass represents a material which includes snow, rain, or hail, of which mass per unit volume is greater than a predetermined value, for example, 0.05 g/cm³ through 0.15 g/cm³. Recirculated air F1, which is inputted from a vehicle via an recirculated air inlet 14 provided at a lower portion of the air conditioner 1, and fresh outside air F2, which is passed through the filter 16, are mixed and passed through the indoor heat exchanger 6, and then the mixed air is supplied into the vehicle via a third duct, in other words, a supply air duct 13, in accordance with an operation of the indoor air blower 4.

FIG. 2 is an enlarged diagram illustrating a blowoff unit of the cyclone fan 5. In the outside air including snow or the like, which is inputted from the outside-air intake duct 10 (illustrated in FIGS. 1), snow or the like, of which mass is heavy, is shifted to the lower portion by centrifugal force and gravity, so that snow or the like, of which mass is heavier than a predetermined mass, is separated by the partition plate 15, and the outside air F2, of which mass is lighter than a predetermined mass, is passed through a separation duct 51 and the filter 16 so as to be inputted to the indoor equipment room 2, and outside air F3, of which mass is heavier than a predetermined mass, is passed through a separation duct 52 and the ejection duct 17 so as to be returned to the outdoor equipment room 3 illustrated in FIGS. 1. In addition, a material having a heavy mass, such as snow or rain, which is inputted from the outside-air inlet 11, is stored at a lower portion of the outdoor equipment room 3 so as to be ejected from a drain tube 18 to the outside.

FIGS. 6 are schematic diagrams illustrating a conventional vehicular air conditioner which is compared with the vehicular air conditioner of the present invention, and FIG. 6A illustrates a topside cross-sectional view, and FIG. 6B illustrates a front cross-sectional view along an “A-A” line. In addition, reference symbols, which are the same as those in FIGS. 1, refer to the same or equivalent parts. A conventional vehicular air conditioner 1 inputs the outside air which is passed from an outside-air inlet 11, which is provided at a side surface of an indoor equipment room 2, through an outside-air filter 12. In a case where the vehicular air conditioner 1 is installed in a ceiling of a vehicle, the vehicular air conditioner 1 is configured in such a way that the outside air is inputted from an upper surface instead of the side surface. As illustrated in FIGS. 6, in the conventional vehicular air conditioner 1, the fresh air is directly inputted from the side surface or the upper surface of the indoor equipment room 2, so that there have been a problem in that the outside-air filter 12 is clogged with snow or the like, or snow, rain or the like is inputted to a vehicle.

As illustrated in FIG. 1, in the vehicular air conditioner according to Embodiment 1 of the present invention, which is compared with the conventional vehicular air conditioner, it is required that an input velocity of the outside air is previously reduced at a level in a state where a material, such as snow, which invades from the outside, can be separated in accordance with a weight, and the vehicular air conditioner is prevented from an invasion of snow, rain or the like, so that the outside-air intake duct 10, which is inclined in a downward direction, is disposed in the outdoor equipment room 3. Therefore, as illustrated in FIGS. 6 corresponding to the conventional vehicular air conditioner, the fresh outside air is not directly inputted from the outside to the indoor equipment room 2, and the fresh outside air is previously inputted from the outside-air inlet 11 of the outdoor equipment room 3 to the outdoor equipment room 3, and the fresh outside air is inputted to the indoor equipment room 2 via the outside-air intake duct 10, which is attached, in a downward direction, to the inside of the outdoor equipment room 3 and includes an aperture inclined in a downward direction, by aspiration force of the cyclone fan 5 in a state where a flow passage is formed in an upward direction, so that it can be suppressed that rain, snow or the like directly invades a vehicle.

Moreover, the cyclone fan 5 is used, and centrifugal force and gravity of a blowoff wind are used, whereby the outside air having a mass being lighter than a predetermined mass, in which snow or the like is not included, can be inputted to the indoor equipment room 2 via the filter 16. Therefore, it is suppressed that rain, snow or the like directly invades the vehicle, and an airflow volume of the outside air is stabilized, so that a performance variation of the device can be reduced, and it can be realized that a maintenance period of the filter is extended and a configuration of the filter is simplified. A material, of which mass is heavier than a predetermined mass, is removed from the outside air by using the cyclone fan 5, whereby the outside-air filter 12, which is disposed at a rear side of a flow passage of the cyclone fan 5, is not easily clogged, and it is suppressed that a volume of the outside air is reduced due to a clogging of the outside-air filter 12, so that the airflow volume of the outside air is stabilized. In addition, the predetermined mass represents a mass per unit volume of the outside air or the air, and it is estimated that, for example, the mass is almost 0.05 g/cm³ through 0.15 g/cm³.

Moreover, the outside air including snow, rain or the like, which is separated by the partition plate 15 of the blowoff unit of the cyclone fan 5, of which mass is heavier than the predetermined mass, is returned to the outdoor equipment room 3 via the ejection duct 17, so that the outside air, of which mass is heavier than the predetermined mass, is passed through the ejection duct 17, whereby a flow velocity of the outside air is decreased, and when the outside air is ejected to the lower portion of the outdoor equipment room 3, snow, rain or the like sinks, and it is possible that the outside air is recirculated so as to be inputted to the outside-air intake duct 10, and the inputted outside air can be effectively used. Moreover, snow, rain or the like is not inputted to the indoor equipment room 2, and snow or rain, which is melted in the outdoor equipment room 3, can be ejected from the air conditioner 1 by the drain tube 18 which is provided at a bottom surface of the outdoor equipment room 3.

### Embodiment 2

FIGS. 3 are enlarged diagrams illustrating a blowoff unit of a cyclone fan 5 according to Embodiment 2 of the present invention, and reference symbols, which are the same as those in FIG. 2, refer to the same or equivalent parts. In FIGS. 3, a partition plate 15a, which partitions separation ducts 51 and 52, can be opened or closed, and an open/close angle of the partition plate 15a is regulated by a variable mechanism 19 which is composed of a motor and the like. In Embodiment 1, the partition plate 15 is fixed with a constant angle so as to be disposed, and the outside air including a material, of which mass is heavier than the predetermined mass, is separated from the outside air, of which mass is lighter than the predetermined mass. However, in Embodiment 2, the variable mechanism 19 is used, and it can performs operations in which a passage of an ejection duct 17 is opened (in FIGS. 3, the partition plate 15a is pulled up) with respect to snow, rain, or a large amount of dust at an desert area or the like, and when snow, rain, dust or the like is not included, the passage of the ejection duct 17 is closed (in FIGS. 3, the partition plate 15a is pulled down). In addition, in Embodiment 2, the predetermined mass is equal to the mass described in Embodiment 1, and the predetermined mass represents a mass per unit volume of the outside air or the air, and it is estimated that, for example, the predetermined mass is almost 0.05 g/cm³ through 0.15 g/cm³, and the predetermined mass is similarly estimated in the following embodiments.

In the air conditioner 1 according to Embodiment 2, the angle of the partition plate 15a is regulated by using the variable mechanism 19, and an airflow volume distribution of the outside air, of which mass is heavier than the predetermined mass, and the outside air, of which mass is lighter than the predetermined mass, can be regulated, so that the angle is regulated in accordance with an environment in which the air conditioner 1 is used, whereby it can be suppressed that the dust is inputted to the indoor equipment room 2.

Moreover, as illustrated in FIG. 3B, the angle of the partition plate 15a is set in a downward direction (lower-left direction in FIG. 3B) with respect to a horizontal direction, whereby a minute material, such as snow, which is hit to the partition plate 15a and is smaller than a predetermined size, is flowed to a left side on the partition plate 15a as indicated by an arrow so as to be inputted to the ejection duct 17, so that a separation performance can be more increased. In this case, the predetermined size represents, for example, a size of snow which is grown, and represents a size of arbitrary-sized snow of which diameter is almost 1 mm through 10 mm. In addition, minute dust, of which size is smaller than the predetermined size, is removed by the filter 16.

### Embodiment 3

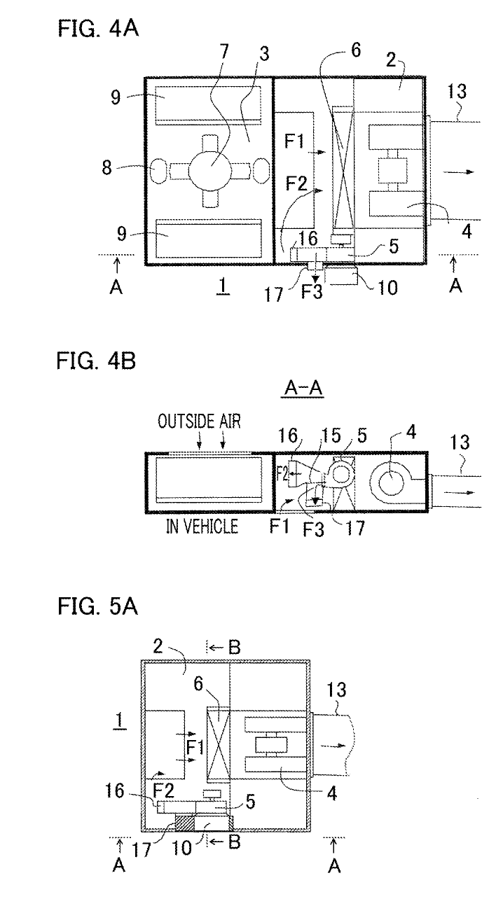

FIGS. 4 are schematic diagrams illustrating an equipment arrangement and a flow of outside air in a vehicular air conditioner according to Embodiment 3 of the present invention, and FIG. 4A illustrates a topside cross-sectional view, and FIG. 4B illustrates a front cross-sectional view along an “A-A” line. In addition, reference symbols in FIGS. 4, which are the same as those in FIGS. 1, refer to the same or equivalent parts.

In FIGS. 4, the outside air is not inputted from an outdoor equipment room 3 as illustrated in FIGS. 1, and an outside-air intake duct 10 is attached at the outside of an indoor equipment room 2, whereby the outside air is directly inputted to the indoor equipment room 2. In addition, the outside air (illustrated in FIG. 4B), which is inputted to the outdoor equipment room 3, is used for cooling outdoor heat exchangers 9, and the outside air is not inputted to a vehicle via the indoor equipment room 2.

The fresh outside air, which is inputted from the outside-air intake duct 10, is circulated by centrifugal force of a cyclone fan 5, which is provided at a nearest position of the outside-air intake duct 10, so as to be blown off toward a left side in FIGS. 4. In this case, centrifugal force and gravity of a blowoff wind are used, whereby the outside air having a mass being lighter than a predetermined mass, in which snow or the like is not included, is inputted to the indoor equipment room 2 via a filter 16 (illustrated as F2), and the outside air having a mass being heavier than a predetermined mass, in which snow or the like is included, is separated by a partition plate 15 so as to be ejected to the outside of the vehicular air conditioner 1 via an ejection duct 17 (illustrated as F3).

In the above-described configuration of the air conditioner 1 according to Embodiment 3, the centrifugal force and the gravity of the blowoff wind of the cyclone fan 5 are used, whereby the outside air having a mass being lighter than the predetermined mass, in which snow or the like is not included, is inputted to the indoor equipment room 2, and the outside air having a mass being heavier than the predetermined mass, in which snow or the like is included, is separated by the partition plate 15 and can be ejected to the outside via an ejection duct 17. The outside air is not inputted via the outdoor equipment room 3, and the outside air is directly inputted from the outside-air intake duct 10 to the indoor equipment room 2, so that there is an effect in which the outside air can be inputted even when the outdoor equipment room 3 has not empty space.

### Embodiment 4

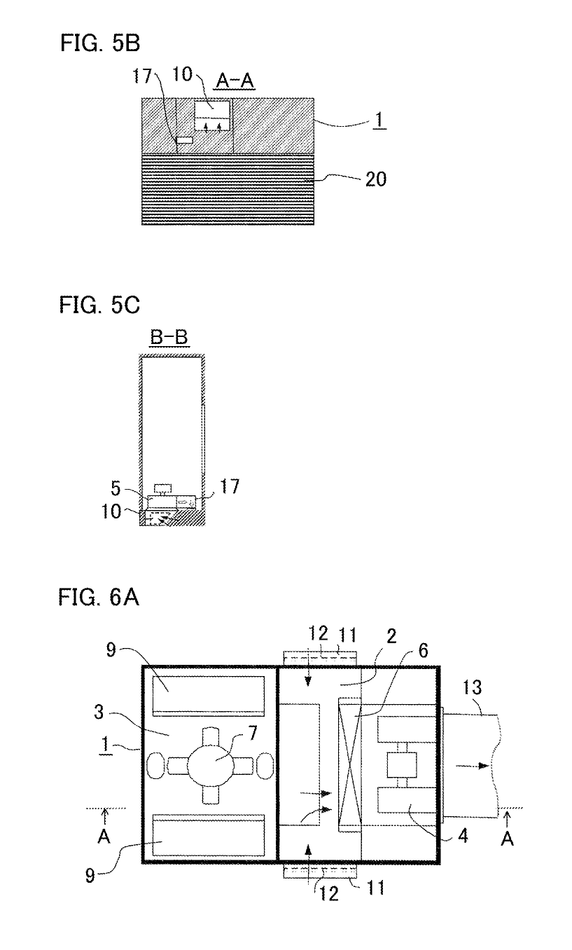

FIGS. 5 are schematic diagrams illustrating an equipment arrangement and a flow of outside air in a vehicular air conditioner according to Embodiment 4 of the present invention, and FIG. 5A illustrates a topside cross-sectional view, and FIG. 5B illustrates a front cross-sectional view along an “A-A” line, and FIG. 5C illustrates a side cross-sectional view along a “B-B” line. In addition, an outdoor equipment room 3 is not illustrated in FIGS. 5, and a positional relation with a vehicle 20 is clearly indicated. Reference symbols in FIGS. 5, which are the same as those in FIGS. 4, refer to the same or equivalent parts.

In FIGS. 4 according to Embodiment 3, the vehicular air conditioner 1 has a form in which the outside-air intake duct 10 is protruded from an outer circumference of the vehicular air conditioner 1. However, as illustrated in FIG. 5A according to Embodiment 4, an outer circumference of the vehicular air conditioner 1 is concaved in accordance with a form of the outside-air intake duct 10, whereby the outside shape of the vehicular air conditioner 1 is formed. As indicated in FIG. 5B and FIG. 5C, the outside-air intake duct 10 is installed at a side portion of the vehicular air conditioner 1 which is disposed at an upper portion of the vehicle 20, and the outside air is directly inputted from an aperture of the outside-air intake duct 10. A separation operation of the outside air by the cyclone fan 5 and the partition plate (not illustrated) is identical to each of separation operations according to Embodiment 1 through Embodiment 3, which are indicated in FIGS. 1 through FIGS. 4.

The vehicular air conditioner 1 is configured as described above, whereby the vehicular air conditioner 1 according to Embodiment 4, which is more compact in comparison with the vehicular air conditioner 1 according to Embodiment 3, cab be realized, and the vehicular air conditioner 1 has an effect in which a wind power resistance can be reduced when a vehicle is driven.

### DESCRIPTION OF THE SYMBOLS

1 is an air conditioner;

2, an indoor equipment room;

3, an outdoor equipment room;

4, an indoor air blower;

5, a cyclone fan;

6, an indoor heat exchanger;

7, an outdoor air blower;

8, a compressor;

9, outdoor heat exchangers or heaters;

10, an outside-air intake duct;

11, an outside-air inlet;

12, an outside-air filter;

13, a supply air duct;

14, an recirculated air inlet;

15 and 15a, partition plates;

16, a filter;

17, an ejection duct;

18, a water distribution tube;

19, a variable mechanism;

20, a vehicle;

51 and 52, separation ducts.

1. A vehicular air conditioner comprising:
an indoor equipment room which is composed of at least an indoor air blower and an indoor heat exchanger, wherein outside air inputted from an outside-air inlet is mixed with recirculated air aspirated by the indoor air blower, and then the mixed air is fed to a cabin via the indoor heat exchanger;
a cyclone fan for separating the inputted outside air to outside air of which mass is lighter than a predetermined mass, and outside air of which mass is heavier than a predetermined mass, by centrifugal force; and
a partition plate for partitioning a passage of the outside air, of which mass is lighter than the predetermined mass, and a passage of the outside air of which mass is heavier than the predetermined mass, at a blowoff outlet of the cyclone fan.

2. A vehicular air conditioner as recited in claim 1, wherein the outside air separated by the partition plate, of which mass is lighter than the predetermined mass, is passed through a filter so as to be inputted to the indoor heat exchanger, and the outside air, of which mass is heavier than the predetermined mass, is passed through an ejection duct so as to be ejected to the outside.

3. A vehicular air conditioner as recited in claim 1, wherein a variable mechanism, by which the partition plate can be opened or closed, is provided.

4. A vehicular air conditioner as recited in claim 2, wherein the partition plate is inclined in a downward direction with respect to a horizontal direction, and a small material, which is hit to the partition plate and is smaller than a predetermined size, is passed through the ejection duct so as to be ejected to the outside.

5. A vehicular air conditioner as recited in claim 1, wherein an outdoor equipment room, which aspirates the outside air, of which mass is heavier than the predetermined mass, from the outside-air inlet by an outdoor air blower, is provided, and an outside-air intake duct, which has an aperture opened in a downward direction with respect to a horizontal direction and guides the inputted outside air to the cyclone fan via the aperture by a flow passage inclined in an upward direction, is disposed in the outdoor equipment room.

6. A vehicular air conditioner as recited in claim 5, wherein the outside air, which is separated by the cyclone fan, of which mass is heavier than the predetermined mass, is returned to the outdoor equipment room, and then the outside air is ejected to the outside.

7. A vehicular air conditioner as recited in claim 2, wherein an outside-air duct is disposed in the indoor equipment room, and the outside air is directly inputted to the indoor equipment room.

8. A vehicular air conditioner as recited in claim 7, wherein the outside-air duct is installed and disposed in the indoor equipment room
